(19) United States
(12) Patent Application Publication
(10) Pub. No.: US 2008/0307397 A1
(43) Pub. Date: Dec. 11, 2008

(54) Program Analysis by Partial Emulation

(76) Inventor: Bill Angell, Felton, CA (US)

Correspondence Address: FISH & RICHARDSON P.C., PO BOX 1022, MINNEAPOLIS, MN, 55440-1022, US

(21) Appl. No.: 11/760,664

(22) Filed: Jun. 8, 2007

(51) Int. Cl. G06F 9/455

(52) U.S. Cl. 717/131

(57) ABSTRACT

Program code is statically analyzed (without actually executing the code) by “virtually” executing the code with a virtual processor or emulator that steps through the code. The analysis includes locating entry and exit points, identifying branch points, analyzing one or more code paths from a branch, noting calls to external functions (e.g., libraries), etc. Programming logic errors can be located, such as calls that never return or isolated code that can never be reached. Analysis can include dynamic analysis of code when emulation is combined with a debugger, for example.

### TECHNICAL FIELD

The subject matter of this patent application is generally related to software development tools.

### BACKGROUND

Conventional code “pre-processors” analyze code to ensure that the code complies with rules of a programming language and instruction set, but cannot detect programming logic errors that lead to execution errors. Conventional debuggers allow trapping of errors in code during execution of the code by a processor. If an error is trapped, the debugger will provide a fault message. The fault message indicates a fault in the code but may not identify the cause of the fault. Accordingly, neither conventional pre-processors nor debuggers can statically analyze code for programming logic errors that cause execution errors.

### SUMMARY

Program code is statically analyzed (without actually executing the code) including by virtually executing the code with a virtual processor or emulator that steps through the code. The analysis includes locating entry and exit points, identifying branch points, analyzing one or more code paths from a branch, noting calls to external functions (e.g., libraries), etc. Programming logic errors can be located, such as calls that never return or isolated code that can never be reached. Analysis can include dynamic analysis of code when emulation is combined with a debugger, for example.

In some implementations, a method includes: statically analyzing code by emulating execution of the code; and identifying programming logic errors discovered in the code during the analyzing.

In some implementations, a system includes an interface for receiving code. A virtual processor is coupled to the interface and configured for statically analyzing the code including emulating execution of the code, and for identifying programming logic errors in the code discovered during the analyzing.

### DESCRIPTION OF DRAWINGS

FIG. 1 is a block diagram showing an example of a system for emulating execution of code and analyzing errors in the execution.

FIG. 2 is a block diagram showing an example of a virtual processor/emulator for emulating execution of code and analyzing errors in the execution.

FIG. 3 is a flow chart showing an example of a process for emulating execution of code and analyzing errors in the execution.

FIG. 4 is a schematic diagram of a computing system that can be used in connection with computer-implemented methods described in this document.

### DETAILED DESCRIPTION

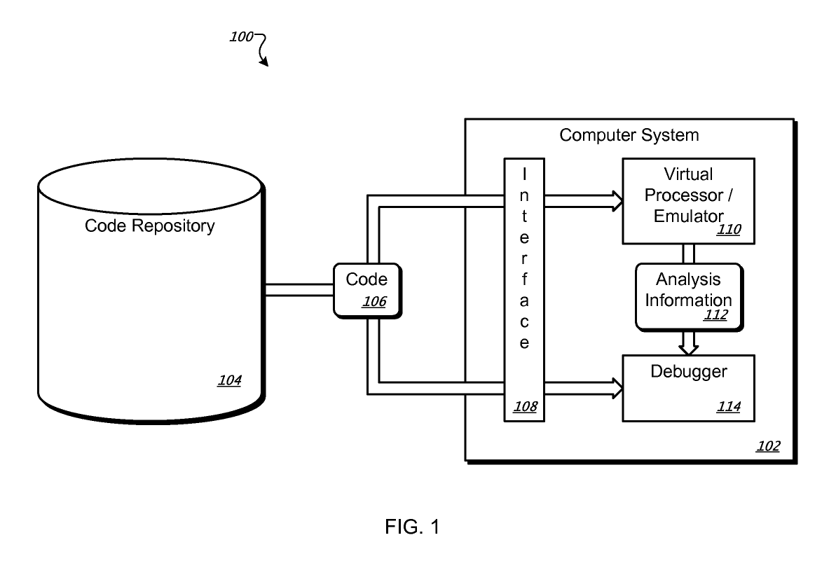

FIG. 1 is a block diagram showing an example of a system 100 for emulating execution of code and analyzing errors in the execution. The system 100 includes a computer system 102 and a code repository 104. The computer system 102 retrieves code 106 from the code repository 104 through an interface 108. In some implementations, the computer system 102 and the code repository 104 are in communication through a network, such as a local area network (LAN). In some implementations, the computer system 102 includes the code repository 104.

The code 106 may be stored at the code repository 104 in a first format, such as a text format. In some implementations, the code 106 is written in a programming language, such as C, C++, and Java. In general, the code 106 may be translated or processed into a second format for execution by the computer system 102. For example, the code 106 may be compiled into bytecode or machine code for execution by the computer system 102. The code 106 is transferred to the computer system 102 in the first pre-processed format. Alternatively, the code 106 may be transferred to the computer system 102 or compiled at the computer system 102 into an intermediate format, such as object code or bytecode. The code 106 may then be analyzed at the computer system 102 in the intermediate format.

In the example shown, a virtual processor and/or emulator 110 receives the pre-processed and/or intermediate code 106 from the code repository 104. The virtual processor/emulator 110 statically analyzes the code 106 by emulating execution of the code 106.

In some implementations, the analyzing includes locating entry and exit points in the code 106. For example, the virtual processor/emulator 110 may locate points at which one or more applications in the code 106 may be initiated (e.g., a “main” function) and points at which the applications may be terminated (e.g., an “exit” function).

In some implementations, the analyzing may include identifying branch points in the code 106. For example, the virtual processor/emulator 110 may identify conditional statements (e.g., “if,” “else if,” and “else” conditions) and/or thread creation statements (e.g., a “fork” statement).

In some implementations, the analyzing includes tracing one or more code paths from a branch point. For example, the virtual processor/emulator 110 may trace a path from an “if” condition and then return to trace a path from an “else” condition associated with the “if” condition. In some implementations, the virtual processor/emulator 110 records or otherwise tracks paths that have been traced, so that each path is only traced once.

In some implementations, the analyzing includes identifying calls to external functions. For example, the virtual processor/emulator 110 may identify calls to a static or dynamic library. The virtual processor/emulator 110 may also identify the library and/or code from the library which contains the called function.

The virtual processor/emulator 110 identifies programming logic errors discovered during the tracing. The virtual processor/emulator 110 may generate information, such as a report, describing the programming logic errors.

In some implementations, the identifying errors includes identifying calls that never return. For example, the virtual processor/emulator 110 may identify a portion of code that when entered is an infinite loop or otherwise fails to return control to the calling code and/or provide a value requested by the calling code.

In some implementations, identifying errors includes identifying code that is never reached. For example, the virtual processor/emulator 110 may identify a path of a conditional statement that is never executed because the condition of the statement is never satisfied.

In some implementations, the virtual processor/emulator 110 may identify a section of the code 106 that is not efficient and/or a section of the code 106 that may be a candidate for optimization. In some implementations, the virtual processor/emulator 110 may scan unknown program code to identify what actions the unknown code performs and/or how the unknown code works. In some implementations, the virtual processor/emulator 110 may search for virus or Trojan horse code embedded in program code. In some implementations, the virtual processor/emulator 110 may scan kernel loadable modules (e.g., “kexts” in the Macintosh Operating System) for malicious or an otherwise undesirable set of instructions or operations.

In some implementations, the virtual processor/emulator 110, another module such as a debugger, or some combination thereof dynamically analyzes the code 106 for programming logic errors. For example, the virtual processor/emulator 110 may provide analysis information to a debugger application. The debugger application may capture information in response to an event, such as a crash, breakpoint, or an exception and correlate the captured information with the analysis to determine, for example, a cause of or solution to the event.

The virtual processor/emulator 110 may output analysis information 112 to a debugger application 114. The debugger 114 is capable of stepping through the execution of the code 106. The debugger 114 may report the values of registers, such as values of variables or memory addresses. In some implementations, the debugger 114 is able to modify the state of the code execution, such as by modifying the values of variables.

The analysis information 112 may include debugging information, such as one or more entry points of a branch table. The entry point describes the location in the code execution space at which the code is initiated. The branch table includes a table of branch targets and offsets or addresses into the table of branch targets. The branch targets describe the paths resulting from the conditional statements and thread creation statements. The offsets and/or addresses into the branch table describe at what state a branch is executed and provide a jump to that branch. The analysis information 112 may include further information determined by the virtual processor/emulator 110, such as the external function calls.

The debugger 114 uses the analysis information 112 to test and/or debug the execution of the code 106. For example, external function call information may allow the debugger 114 to step into code associated with an external library. The analysis information 112 may include probe points, such as possible locations for runtime errors in the code 106. The analysis information 112 may include the status of registers, such as whether a register has been initialized, set with the value of another register, undefined/unset, or a value that is assigned to an undefined register (e.g., a pointer to a memory location where the pointer has not been initialized). The analysis information 112 may include state information. The debugger 114 may use the state information to modify the state of the execution of the code 106 to test a particular series of events or a particular portion of the code 106.

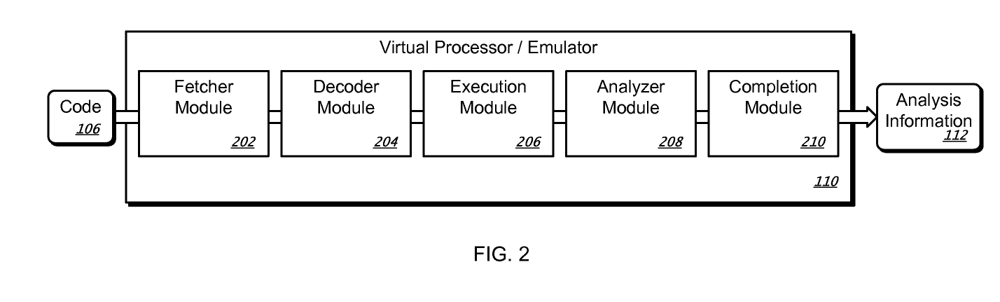

FIG. 2 is a block diagram showing an example of the virtual processor/emulator 110 for emulating execution of code and analyzing errors in the execution. The virtual processor/emulator 110 includes a fetcher module 202, a decoder module 204, an execution module 206, an analyzer module 208, and a completion module 210.

The fetcher module 202 receives the code 106 and selects an instruction from the code 106. The fetcher module 202 verifies that an address of the instruction is valid. If the address is valid, then the fetcher module 202 puts a copy of the instruction in an internal work area, such as a memory space accessible by the virtual processor/emulator 110. The fetcher module 202 then passes control to the decoder module 204.

The decoder module 204 partially parses the instruction into an operation code (opcode), such as a machine language instruction. In some implementations, the decoder module 204 may parse the instruction into an extended opcode. The opcode may have one or more associated operands, such as a value to be placed in a memory register or a memory address to jump to. The decoder module 204 looks up the opcode in a table or list of valid instructions. If the decoder module 204 determines that the opcode is valid, then the decoder module 204 finishes the parsing of the instruction using information found in the table.

The instruction table contains information about the specific instruction. For example, the instruction may have associated information describing execution on a particular processor, such as a PowerPC™ processor. The table may include formats for the physical layout of the instruction. The table may indicate what format to use and which bits specify source and target registers. Later, the analyzer module 208 classifies the instructions while performing its analysis. The table may include classification information, such as whether the instruction is a floating point, a vector, a branch, a load, a store, a trap, or another type of instruction. The table may also include information describing whether or not the instruction is privileged, if the instruction uses 64-bit registers or 32-bit, if the instruction sets the condition register, and/or if the instruction is signed or unsigned. The table also indicates whether or not the instruction is emulated. In some implementations, trivial and/or irrelevant instructions need not be emulated. However, even where an instruction is not emulated the table may identify which registers are used and which registers modified for tracking purposes.

The decoder module 204 then passes control to the execution module 206. Alternatively, if the instruction is trivial or not relevant to analysis of the code 106, then the decoder module 204 may skip the processing performed by the execution module 206.

The execution module 206 uses the information determined by the decode module 204 to emulate the individual instructions of the selected portion of the code 106. In some implementations, the execution module 206 only emulates a portion of the instructions, such as a portion of the instructions needed to generate an analysis of the code 106. In addition, the execution module 206 may partially emulate a particular instruction.

The execution module 206 may access one or more memory registers, perform one or more operations, and place the result in a temporary holding area, such as a memory location accessible by the virtual processor/emulator 110. In some implementations, the execution module 206 waits to write the result to target registers until a later point in the processing which will be described below. This allows the execution module 206 to ignore the results of the instruction or substitute another set of results after further analysis of the code 106.

The execution module 206 gathers and records values of registers. Particularly, the execution module 206 tracks the state and history of registers and memory. This information is used by both the execution module 206 and the analyzer module 208. The execution module 206 tracks the result of an operation by combining the tracking for the source operands and the result of the operation. For example, a trace of an operation may include an indication of whether the operand has previously been set or whether the operand contains a value that can be interpreted as an address within the code 106 under test. The trace may also include an indication of whether the operand contains a return address to a location on the stack, for example. When the execution module 206 completes its processing, control passes to the analyzer module 208.

The analyzer module 208 determines what actions the code 106 under test actually performs. In addition, the analyzer module 208 handles the actual memory loads and stores determined by the execution module 206. The analyzer module 208 may load tracking information, previously saved by the execution module 206 in emulated memory, into a register when performing a store or load.

In some implementations, the analyzer module 208 also handles branching, updating a Program Counter (PC) and link registers for branches, and function calls. When processing a function call, the analyzer module 208 creates a branch to the function with an instruction that also saves the address of the instruction immediately following the branch instruction. This allows the function to return when its instructions have finished. The analyzer module 208 sets the return register and also sets the PC (e.g., its virtual PC) to the target address. The target address (the function being called) can be either internal to the code 106 being analyzed or external. In case of an external function, the analyzer module 208 may continue execution after the call as if the function had been called and then it returned.

In the case of an internal function, the analyzer module 206 may checkpoint or save the current context. The analyzer module 206 may save the emulated registers and the emulated memory. The analyzer module 206 recursively calls the scan code. In some implementations, this may appear as if the analysis is starting over with the new function. Scanning and analysis of the new function continues until it returns to its caller. At the return point, the analyzer module 206 discards any context generated by the function, including registers and any modified memory.

In some implementations, the analyzer module 206 processes branches, such as conditional branches and unconditional branches. Unconditional branches do not change the flow of the analysis and the emulated PC is simply updated. Conditional branches include additional processing. The analyzer module 206 checks both the success and failure paths of a conditional branch. Like the internal function call, the analyzer module 206 saves the context and scans down a particular code path by calling itself recursively. When the end of that path is reached (e.g., exit, invalid instruction, branch outside of test range, or an instruction that has already been analyzed), then the analyzer module 206 returns. The return restores the state back to the original branch instruction. The analyzer module 206 then continues with the next code path in the conditional statement. In some implementations, the analyzer module 206 analyzes each code path in the conditional statements.

The actions described thus far with respect to modules 202, 204, 206, and 208 include the analysis of a single instruction in the code 106. At this point control passes to the completion module 210.

The completion module 210 moves the tentative instruction results determined by the modules 202, 204, 206, and 208 to the actual emulated registers. The completion module 210 then passes control to the fetcher module 202 and processing of the next instruction in the code 106 begins.

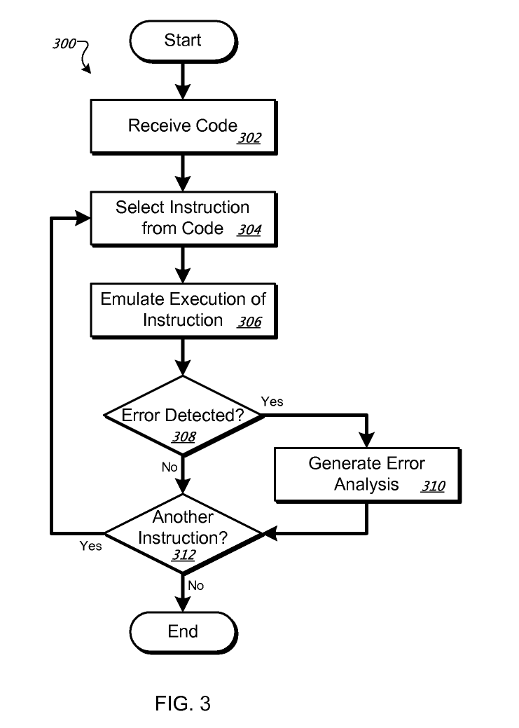

FIG. 3 is a flow chart showing an example of a process 300 for emulating execution of code and analyzing errors in the execution. The process 300 begins with receiving (302) code. For example, the computer system 102 may receive the code 106 from the code repository 106 through the interface 108.

The process 300 selects (304) an instruction from the code. For example, the fetcher module 202 in the virtual processor/emulator 110 may select an instruction from the code 106.

The process 300 emulates (306) execution of the selected instruction. For example, the execution module 206 in the virtual processor/emulator 110 may emulate execution of the instruction selected from the code 106.

If the process 300 detects (308) an error, then the process 300 generates (310) an analysis of the detected error. For example, the analyzer module 208 in the virtual processor/emulator 110 may detect an error, such as an infinite loop or isolated code, while emulating the instruction and generate an analysis of the error.

If the process 300 determines (312) that there is another instruction in the code, then the process 300 selects (304) another instruction from the code. For example, the virtual processor/emulator 110 may continue to process the code 106 until all of the instructions in the code 106 have been emulated. Alternatively, the virtual processor/emulator 110 may target particular portions of the code 106 for emulation and error analysis.

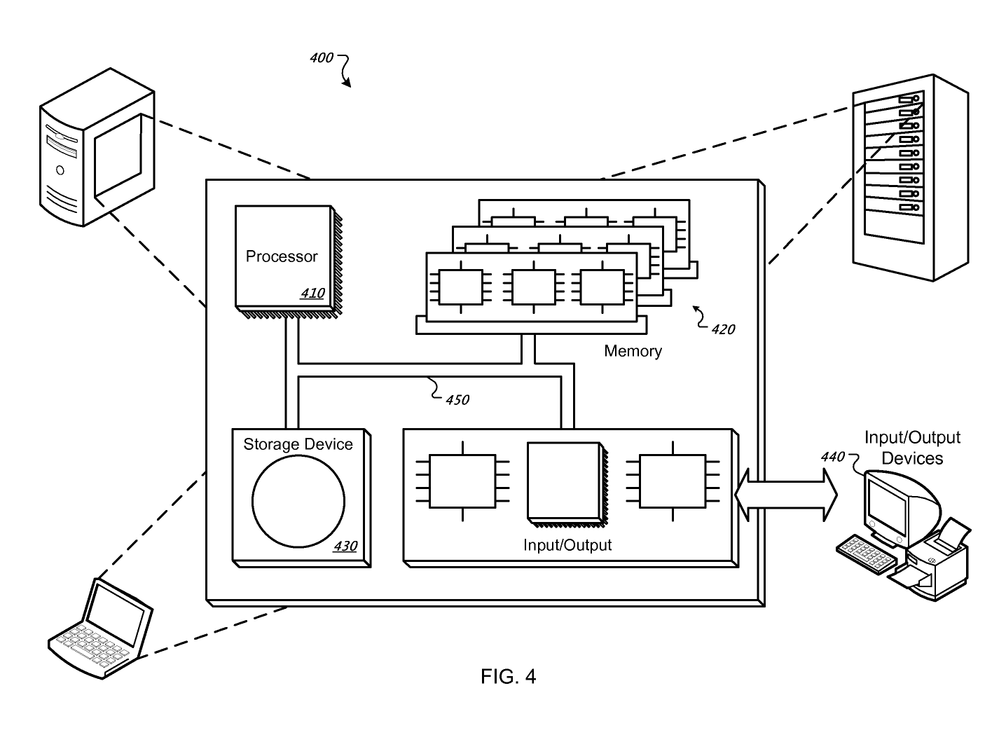

FIG. 4 is a schematic diagram of a generic computer system 400. The system 400 can be used for the operations described in association with any of the computer-implement methods described previously, according to one implementation. The system 400 includes a processor 410, a memory 420, a storage device 430, and an input/output device 440. Each of the components 410, 420, 430, and 440 are interconnected using a system bus 450. The processor 410 is capable of processing instructions for execution within the system 400. In one implementation, the processor 410 is a single-threaded processor. In another implementation, the processor 410 is a multi-threaded processor. The processor 410 is capable of processing instructions stored in the memory 420 or on the storage device 430 to display graphical information for a user interface on the input/output device 440.

The memory 420 stores information within the system 400. In one implementation, the memory 420 is a computer-readable medium. In one implementation, the memory 420 is a volatile memory unit. In another implementation, the memory 420 is a non-volatile memory unit.

The storage device 430 is capable of providing mass storage for the system 400. In one implementation, the storage device 430 is a computer-readable medium. In various different implementations, the storage device 430 may be a floppy disk device, a hard disk device, an optical disk device, or a tape device.

The input/output device 440 provides input/output operations for the system 400. In one implementation, the input/output device 440 includes a keyboard and/or pointing device. In another implementation, the input/output device 440 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier, e.g., in a machine-readable storage device or in a propagated signal, for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

A number of implementations have been described. Nevertheless, it will be understood that various modifications may be made. For example, elements of one or more implementations may be combined, deleted, modified, or supplemented to form further implementations. As yet another example, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

What is claimed is:

1. A method comprising:
statically analyzing code by emulating execution of the code; and
identifying programming logic errors discovered in the code during the analyzing.

2. The method of claim 1, where analyzing further comprises:
locating entry and exit points in the code.

3. The method of claim 1, where analyzing further comprises:
identifying branch or break points in the code.

4. The method of claim 1, where analyzing further comprises:
tracing one or more code paths originating from a branch point.

5. The method of claim 1, where analyzing further comprises:
identifying calls to external functions.

6. The method of claim 1, where identifying programming logic errors further comprises:
identifying calls that are never returned.

7. The method of claim 1, where identifying programming logic errors further comprises:
identifying isolated code that is never reached.

8. The method of claim 1, where identifying programming logic errors further comprises:
dynamically or statically analyzing the code for programming logic errors.

9. The method of claim 1, further comprising:
generating information describing programming logic errors discovered during the tracing.

10. The method of claim 9, further comprising:
using the information to identify probe points for debugging the code during execution of the code.

11. A system comprising:
an interface for receiving code; and
a virtual processor coupled to the interface and configured for statically analyzing the code by emulating execution of the code, and for identifying programming logic errors in the code discovered during the analyzing.

12. The system of claim 11, where the virtual processor is configured to locate entry and exit points in the code.

13. The system of claim 11, where the virtual processor is configured to identify a branch or break in the code.

14. The system of claim 11, where the virtual processor is configured to analyze one or more code paths originating from a branch point.

15. The system of claim 11, where the virtual processor is configured to identify calls to external functions.

16. The system of claim 11, where the virtual processor is configured to identify calls to external functions that are never returned.

17. The system of claim 11, where the virtual processor is configured to identify isolated code that is never reached.

18. The system of claim 11, where the virtual processor is configured to dynamically analyze the code to identify programming logic errors.

19. The system of claim 11, where the virtual processor is configured to generate information describing programming logic errors discovered during the tracing.

20. The system of claim 11, where the virtual processor is configured to use the information to identify probe points for debugging the code during execution of the code.

21. A computer-readable medium having instructions stored thereon, which, when executed by a processor, causes the processor to perform operations comprising:
statically analyzing code by emulating execution of the code; and
identifying programming logic errors discovered in the code during the analyzing.

22. The computer-readable medium of claim 21, where analyzing further comprises:
locating entry and exit points in the code.

23. The computer-readable medium of claim 21, where analyzing further comprises:
identifying branch or break points in the code.

24. The computer-readable medium of claim 21, where analyzing further comprises:
analyzing one or more code paths originating from a branch point.

25. The computer-readable medium of claim 21, where analyzing further comprises:
identifying calls to external functions.

26. The computer-readable medium of claim 21, where identifying programming logic errors further comprises:
identifying calls that are never returned.

27. The computer-readable medium of claim 21, where identifying programming logic errors further comprises:
identifying isolated code that is never reached.

28. The computer-readable medium of claim 21, where identifying programming logic errors further comprises:
dynamically analyzing the code for programming logic errors.

29. The computer-readable medium of claim 21, further comprising:
generating information describing programming logic errors discovered during the analyzing.

30. The computer-readable medium of claim 21, further comprising:
using the information to identify probe points for debugging the code during execution of the code.

31. A system comprising:
means for statically analyzing code by emulating execution of the code; and
means for identifying programming logic errors discovered in the code during the analyzing.
